(19) United States
(12) Patent Application Publication
(10) Pub. No.: US 2004/0139092 A1
(43) Pub. Date: Jul. 15, 2004

(54) Document access system supporting an application user in accessing external documents

(76) Inventors: Robert W. Jones JR., Downingtown, PA (US); Paul Steenkamer, Wilmington, DE (US); Arthur J. Widmann, Exton, PA (US)

Correspondence Address: Alexander J. Burke, Intellectual Property Department, 5th Floor, 170 Wood Avenue South, Iselin, NJ, 08830, US

(21) Appl. No.: 10/678,370

(22) Filed: Oct. 3, 2003

Related U.S. Application Data
(60) Provisional application No. 60/439,264, filed on Jan. 10, 2003.

(51) Int. Cl. G06F 7/00

(52) U.S. Cl. 707/100

(57) ABSTRACT

A document access and retrieval system for use in a hospital laboratory environment. The system permits users of a main application to obtain customized, user-specific access to various documents, internet addresses and other external links based on the application subparts or objects to which the user has authorized access. The access links appear as submenu items appearing under the Help menu associated with a selected application object. The system includes a links processor that is interconnected to a links map which correlates various software application objects with the security level of a system user. The system includes a security processor which evaluates user security data and then requests a list of available access link information from the main application. Users cannot access parts of the application to which they do not have specific access. The system enables administrators of model software based applications to add and manage links to external sources based on the user's role in the application and the user's security access.

The present Utility patent application is based on Provisional patent application no. 60/439,264, filed on Jan. 10, 2003.

### BACKGROUND OF THE INVENTION

1. Field of the Invention

The present invention relates generally to the field of software application management, and more particularly to systems that facilitate the sharing and integration of documentation between multiple files and software applications.

2. Background of the Invention

The modern laboratory environment is usually dependent on a variety of computers and their related software. Data and software applications are often made available to laboratory personnel by means of a Laboratory Information System (LIS) installed on the computer system. The LIS is typically configured to interact with the user by means of a software control module that displays some sort of program window that includes a dialog, pull-down menu, pop-up menu and/or other similar user interface elements. The typical (LIS) is a model system and the programming code is not customized for the end user. The LIS as well as other model system applications do not enable authorized users of particular portions or objects of an application to access user specific documentation. Further, current systems do not enable users of the LIS to define custom menu options that link user created or user specific documents to a LIS application.

Current file access or document linking technology uses the concept of a “Favorites” system, which utilizes a list of bookmarks, appearing on a pull-down menu, for example, to store a path pointing to each favorite, the path containing the internet, file or folder address corresponding to the entries that appear in the Favorites menu listing. The “Favorites” list is managed by individual end-users rather than system administrators, thereby remaining separate from the LIS. The list is, therefore, not incorporated into the workflow of all users of the LIS. The “Favorites” function does not support the creation of user links that are associated with an authorized user of a specific software application section (application object), or links that are associated with a user's role or with a particular organization. Because the “Favorites” protocol is a user-managed method of organizing links to web pages, files and folders, any potential group wide benefits of such linkages are not realized. State of the art “Favorites” systems do not provide a security function, meaning that links are readily available to any person who happens to be using a particular computer or terminal, regardless of that particular user's level of authorization. In some internet related applications (such as Microsoft Outlook), access to the Favorites menu cannot be disabled.

The LIS is by its nature a multi-entity system and is managed by a systems administrator. For example, computer access to laboratory test procedures is essential to the workflow of a medical technologist using a LIS application object related to laboratory testing. A drawback of a Favorites based system is that it is not context specific or otherwise associated with a user's workflow. Each item on the Favorites menu may be selected individually as needed by the user and does not appear on any other menu even when that particular Favorite link may be highly relevant to the application object being accessed by a user.

Many data management systems exist which attempt to address various data access issues. Some such systems link user-generated documentation to a software application by using a documentation repository for storing user generated documentation. A linking module contained within a software application permits a user of the application to access the documentation repository while running the application.

While the foregoing systems address various aspects of data integration problems, they do not permit the user of a laboratory information system to access third party files and applications directly from the laboratory system. These systems do not enable system users to define custom menu options that link to user-specific documents. A need exists for a system that provides access to such files and applications based on the user's role in an organization, the user's security access and the identity of the user's organization.

### BRIEF SUMMARY OF THE INVENTION

In accordance with principles of the present invention, a system enables a user of an application object, which is an executable portion of an executable application, to access documents external to the application. The system includes a map associating a set of access links with (a) an application object identifier; and (b) an organization identifier identifying an organization. The set of access links supports access to documents external to said application. A link processor provides data representing a set of access links to a user in response to a received organization identifier and a received application object identifier. A command processor initiates access to an external document using a link in the set of access links in response to user command.

A system according to the principles of the present invention provides secure and seamless integration between a laboratory information system and user-specific external documentation, third party software applications, and/or internet sites. Such a system enables administrators of model software based applications to add and manage access links to external sources, thereby permitting users of such applications to access third party files and applications directly from the application.

### BRIEF DESCRIPTION OF THE DRAWING

FIG. 1 is a schematic block diagram illustrating system workflow of the document access system of the present invention;

FIG. 2 is an embodiment of a graphical user interface of the present invention that permits a system administrator to associate security scenarios with user roles;

FIG. 3 is an embodiment of a graphical user interface of the present invention that permits a system administrator to associate security scenarios with an organization;

FIG. 4 is an embodiment of a graphical user interface of the present invention that permits a system administrator to associate security scenarios with security actions;

FIG. 5 is an embodiment of a graphical user interface of the present invention that permits a system administrator to associate individual users with security scenarios;

FIG. 6 is an embodiment of a graphical user interface of the present invention that permits an individual user to select an access scenario;

FIG. 7 is an example of a document link map utilized as part of the system depicted in FIG. 1;

FIG. 8 is an embodiment of a graphical user interface depicting an example of a user defined table employed by the system shown in FIG. 1.

FIG. 9 is an embodiment of a graphical user interface depicting sample links available to authorized users associated with a first organization when accessing a patient entry object by means of the system depicted in FIG. 1;

FIG. 10 is an embodiment of a graphical user interface depicting sample links available to authorized users associated with a second organization when accessing a patient entry object by means of the system depicted in FIG. 1; and

FIG. 11 is an embodiment of a graphical user interface depicting sample links available to users in the role of a medical technologist utilizing the system shown in FIG. 1.

### DETAILED DESCRIPTION OF THE INVENTION

In the drawing, corresponding elements in different figures are referred to by the same reference number.

Computer systems connected to communications networks can generally be classified as “servers” and “clients”, depending on the role the computer systems fulfill with respect to either requesting information or storing and providing information. Computers which are operated by end-users to access information are typically called “client” systems. Computers which store information and provide the information to client computers are typically referred to as “server” systems. Therefore, server systems are responsible for receiving information requests from client systems, performing the data processing needed to satisfy those requests, and forwarding the results or information requested to the client system. The client computer typically contains a program (client application) to help the user interact with the server, the program being referred to generically as the client navigator. These client/server systems permit processing to be distributed among different computers.

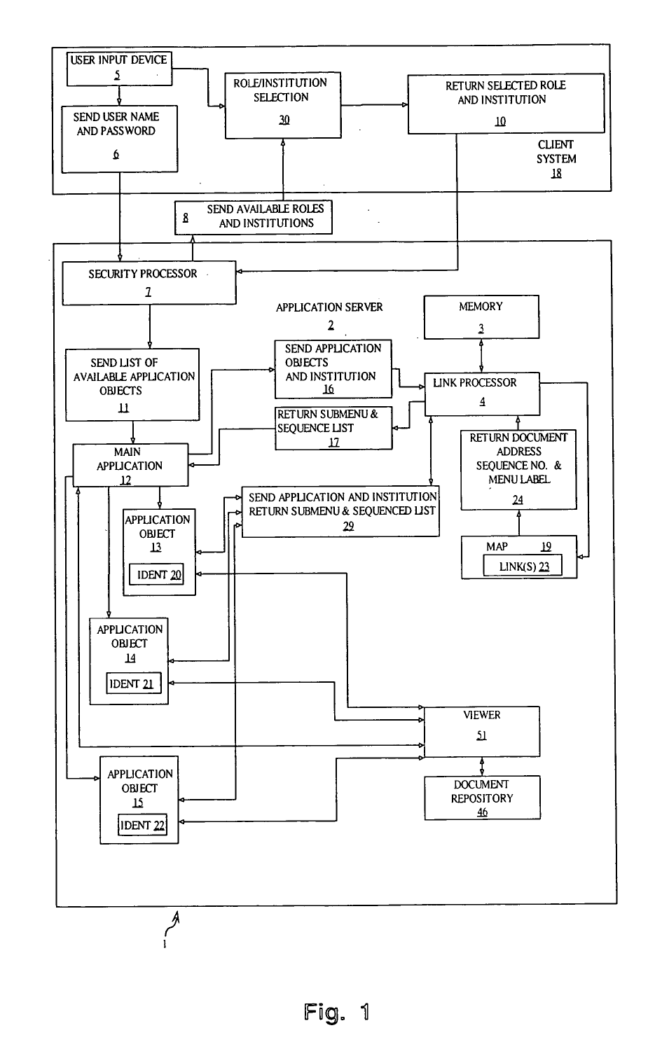

The laboratory information system (LIS) of the present invention is a software application designed to meet the needs of different types or groups of end-users in a hospital laboratory setting. Examples of different groups of users include phlebotomists, receptionists, medical technologists and system administrators. Referring to FIG. 1, the laboratory information system 1 is seen to include an application server 2 and a client system 18. The application server 2 is a computer containing a memory 3 and a command or link processor 4 interconnected via a networking connection (not shown to simplify the figure) to at least one client system 18 so as to form a network. The network may comprise an interconnected system of networks such as an intranet, the internet and the World Wide Web. One skilled in the art will understand that requests sent from the client system 18 to the application server 2, and return of information from the application server 2 to the client system 18 all take place over the networking connection (not shown). One function of the application server 2 is to provide the client system 18 with access links or addresses associated with external documents or applications.

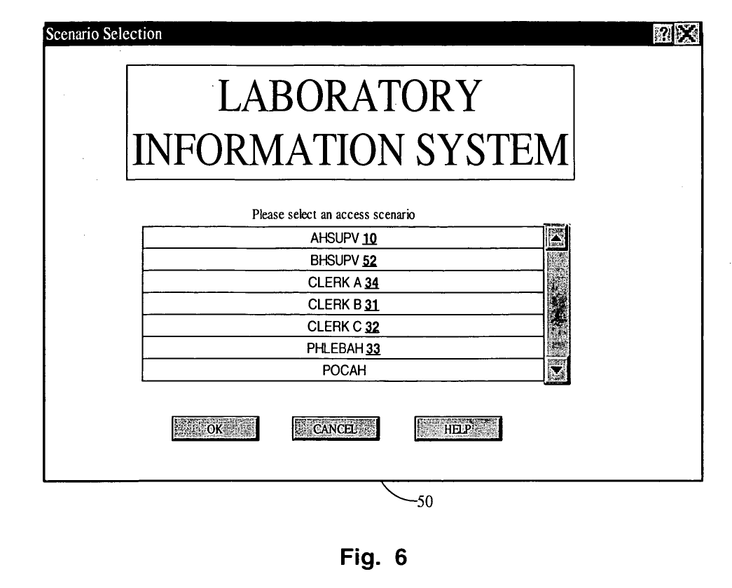

A user obtains access to the system 1 by logging into the system 1 via any suitable input device 5 in conjunction with a-graphical user interface of known arrangement that is part of the client navigator software operating on client system 18. The sign-on procedure requires the entry of a user name and password 6 that is sent to a security processor 7 which is a part of the application server 2. In response to receipt of an authorized user name and password, an authorization processor in the security processor 7 sends a list of user roles 8 (e.g. job titles) and associated institutions (termed access scenarios) available for the user name to the client system 18. The user then selects 30 one of the user roles and institutions from the list sent from the security processor 7 using the input device 5 in conjunction with the graphical user interface 50 (FIG. 6) that displays the list of possible user access scenarios, 10, 31, 32, 33, 34 and 52, for example. The selected role, and institution is then returned 10 to the security processor 7 in the application server 2.

The content of the displayed list of access scenarios is a function of relationships defined by a system administrator or other authorized user. The process used by the system administrator or other authorized user to define these relationships is described below.

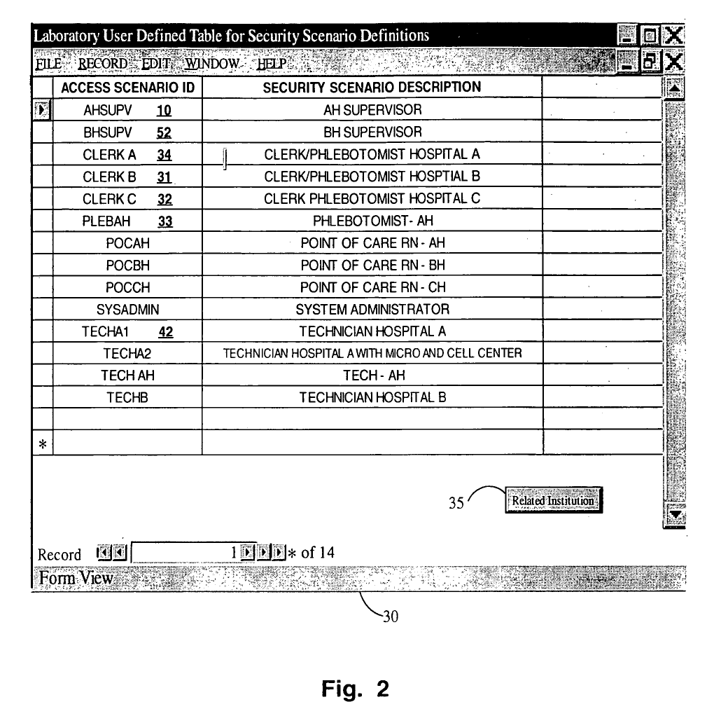

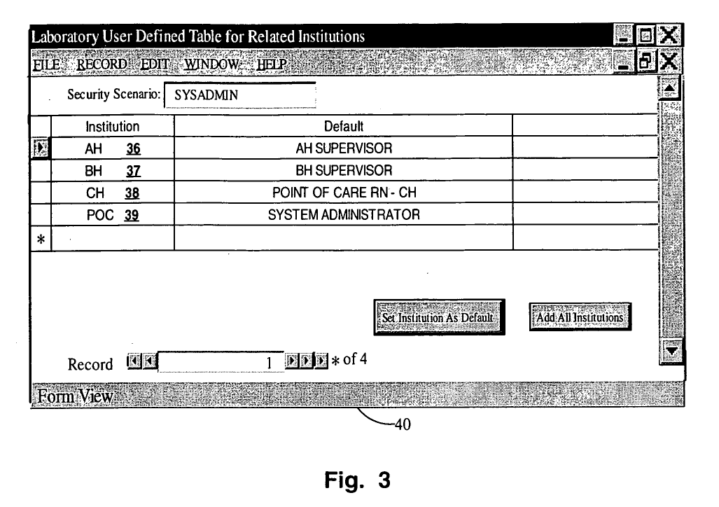

Referring to FIG. 2, the system administrator is able to associate each potential system user's job title or role and institution (i.e. access scenario) with a security scenario. Each access scenario, 10, 31, 32, 33, 34, 42 and 52, for example, is associated with a security scenario description. The system administrator may add additional security scenarios by adding a new entry containing the identifier of the access scenario and the corresponding security scenario description to the list illustrated in FIG. 2. When the user signs on and selects one of the access scenarios depicted by interface 50 (FIG. 6), the system 1 processes the security information associated with the corresponding security scenario. Referring to FIG. 3, the system administrator may give a user access to more than one hospital in the hospital system. By activating button 35 (FIG. 2) the graphical user interface 40 of FIG. 3 is displayed and the institutions 36, 37, 38 and 39 associated with a particular role are depicted, and may be selected and/or edited by the system administrator.

The selection of a particular access scenario during sign-in (FIG. 6) causes the security processor 7 (FIG. 1) to send 11 a system-administrator-defined list of application objects that are available to the particular user role and institution to the main application 12. As used herein, the term application object is intended to include any type of computer instruction or computer executable code that is a separable portion, module or independently executable subpart of a larger software program or application. This is described in more detail below. For example, a phlebotomist may have access only to the specimen entry related parts of application 12; a medical technologist may have access to all patient, order and test result entry related parts of the application 12 (FIG. 1); and a systems administrator may have access to all parts of the application 12 including administrative reports and system maintenance. The system administrator assembles this list in the following manner.

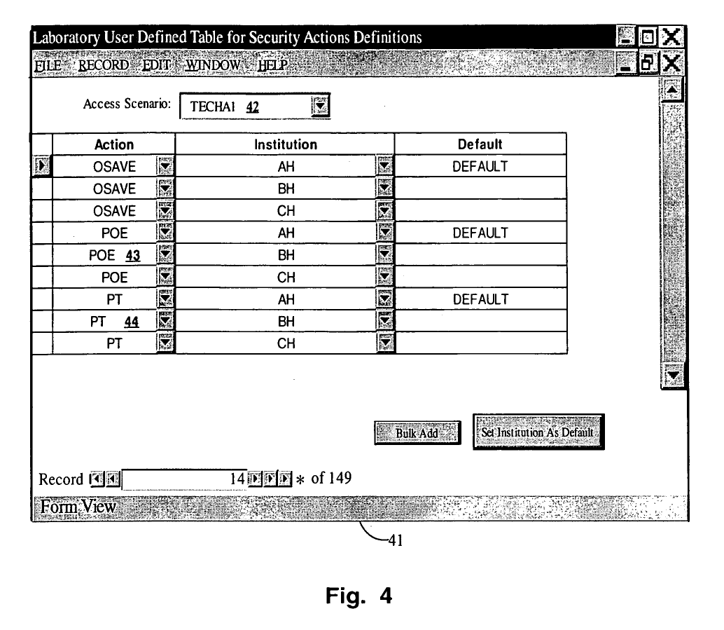

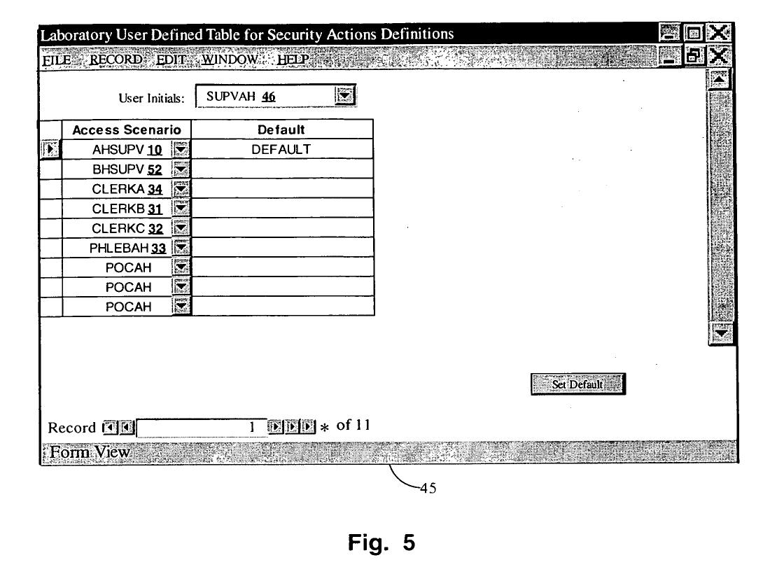

Referring to FIG. 4, the graphical user interface display 41 allows the system administrator to associate a role 42 (technician hospital A, in the illustrated example) with an action to be taken by security processor 7. Each security action, 43 and 44, for example, defines which application objects and which tasks within an application object the group of end-users defined by the access scenario 42 can access. Referring now to FIG. 5, display 45 allows the system administrator to associate a particular user 46 with one or more roles 10, 31, 32, 33, 34 and 52, for example.

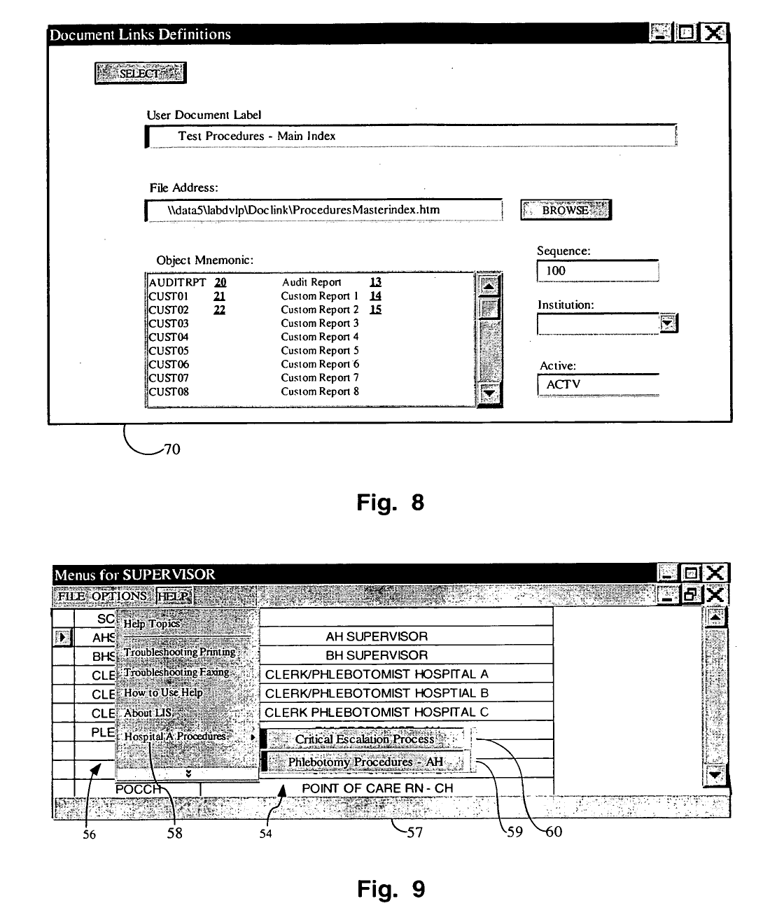

External documents, e.g. text or graphical documents and/or internet sites, are associated with different application objects of the main application 12 in which they are deemed useful by the system administrator. For example, these external documents may include information such as (a) test procedures, (b) chemistry procedures, (c) microbiology procedures, (d) hematology procedures (e) phlebotomy procedures, (f) instrument support, (g) an electronic patient medical record, (h) orders to perform patient procedures, (i) laboratory test results and (j) a patient visit. These external documents may be in the form of (a) a web page, (b) an HTML file, (c) a Word document, (d) an SGML document, (e) an XML document, (f) a multimedia file, (g) an Excel file, (h) a Portable Document Format file, (i) an executable file, (j) a text file and/or (k) an accessible file. As seen in FIG. 8, the system administrator has access to a graphical user interface 70 which permits the association of various application object identifiers 20, 21 and 22 with respective application object descriptions 13, 14 and 15. By way of illustration, the main application 12 (FIG. 1) contains numerous application objects, for example reports 13, 14 and 15. The different application objects may include, for example, functions for patient/order entry, specimen entry, test result entry, results inquiry, patient reporting, administrative reports and system maintenance. Table I depicts an example of a table that is the source of the entries in the list of available application objects appearing in graphical interface 70.

TABLE I

| APPLICATION | |
|---|---|
| OBJECT MNEMONIC | |
| OR IDENTIFIER | APPLICATION OBJECT NAME |
| AUDITRPT 20 | AUDIT REPORT 13 |
| CUST01 21 | CUSTOM REPORT 1 14 |
| CUST02 22 | CUSTOM REPORT 2 15 |
| CUST03 | CUSTOM REPORT 3 |
| CUST04 | CUSTOM REPORT 4 |
| CUST05 | CUSTOM REPORT 5 |
| CUST06 | CUSTOM REPORT 6 |
| CUST07 | CUSTOM REPORT 7 |
| CUSTO8 | CUSTOM REPORT 8 |
| CUST09 | CUSTOM REPORT 9 |
| CUST10 | CUSTOM REPORT 10 |
| DAV | DOCUMENT AUDIT VIEW |
| EVTMON | EVENT MONITOR |
| INTFC | INTERFACE |
| INTRIQ | INTERFACE RESULTS INQUIRY |
| JOBSCD | JOB SCHEDULER |
| MENU | MAIN MENU |
| MGTRPT | MANAGEMENT REPORTS |
| ORDERS | ORDERS |
| POE | PATIENT/ORDER ENTRY |
| QCRPT | QUALITY CONTROL REPORTS |
| QCUDT | QC UDT MAINTENANCE |
| REPORT | PATIENT REPORTS |
| RSLINQ | RESULTS INQUIRY |
| SECUDT | SECURITY UDT MAINTENANCE |
| SMPTRK | SAMPLE TRACKING |
| SPCMN | SPECIMENS |
| TATMON | TAT ALERT MONITOR |
| TESTS | TESTS |
| UDT | UDT MAINTENANCE |
| USRMSG | USER MESSAGING |
| VISITS | VISITS |
| WPMENU | WORD PROCESSING MENU |
| XPORT | TRANSPORTS |

The system administrator is able to associate an external document to a selected application object in the following manner. Using the BROWSE button, an external document, found either locally, on an interconnected LAN or on the internet, may be found and selected in a known manner. The file address of the selected external document is displayed in the File Address display box of FIG. 8. This file address may be (i) a universal resource locator (URL), (ii) an internet protocol address, (iii) a storage file directory address, (iv) a storage file address, (v) a communication port address, (vi) a server address, or (vii) an address for use in locating a document. A title for this external document may be entered in the User Document Label display box. A selected institution may be entered in the Institution display box. As indicated by the arrow box to the right of the Institution display box, the institution may be selected from a list of allowable institutions displayed by pressing the arrow box, all in a known manner. The entry may be marked active by making an appropriate entry in the Active display box. One or more of the application objects in the list box, in which the selected external document is deemed useful, may be selected. Pressing the SELECT button saves the data entered and/or edited in this graphical user interface 70 in an access link database map 19 (described below). Use of such saved data will be described in more detail below.

Referring again to FIG. 1, in response to the information provided by the system administrator, as represented by the displays of FIG. 4 and FIG. 5, the security processor 7 sends 11 to the main application 12 a list of application objects available to the user, as specified by the security action(s) 43, 44, associated with the role and institution selected by that user (FIG. 4). The security processor 7 thereby ensures that users cannot access parts of the application 12 to which they do not have specific authorization. In response to receipt of the application object list 11, the main application 12 sends 16 a request to the link processor 4 for access links (described below) that are available for the application objects appearing on the list 11. The request-sent 16 to link processor 4 by the main application 12 includes the listed application object identifier(s) 13, 14, 15 and an institution identifier associated with the selected user 10.

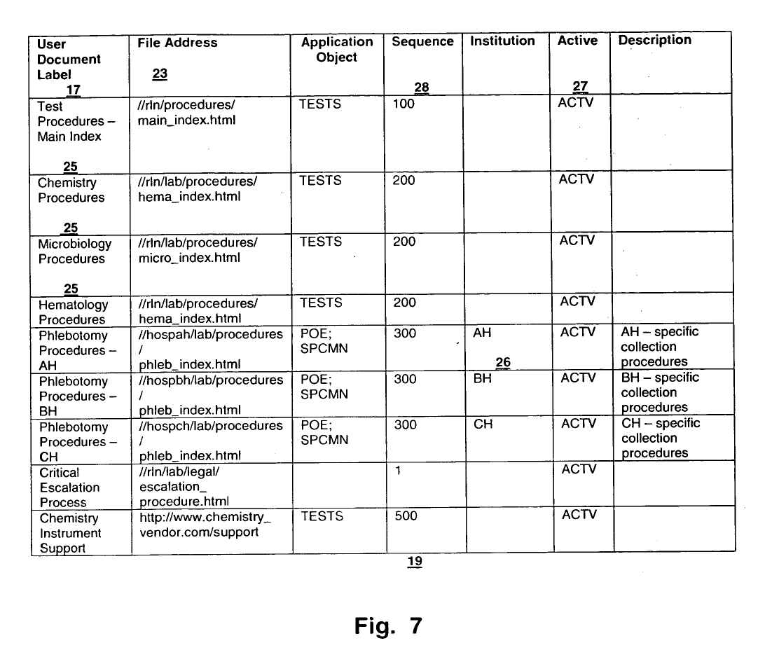

Referring to FIG. 7, the structure of an access link database map 19 is depicted which stores entries containing access link profiles created by the system administrator (using the graphical user interface illustrated in FIG. 8) to associate particular file addresses or access links 23 (FIG. 1) with an institution identifier and application object. Some entries (e.g. Phlebotomy Procedures—AH) may be associated with one or more specified application objects and one or more specified institutions; some (not shown) may be associated with any application object and one or more specified institutions; some (e.g. Chemistry Procedures) are associated with one or more specified application objects and any institution; and some (e.g. Critical Escalation Process) are associated with any application object and any institution. More specifically, entries with values in the Application Object column are associated with the specified application object(s) and entries with no value in the Application Object column are associated with all application objects. Similarly, entries with values in the Institution column are associated with the specified institution(s) and entries with no value in the Institution column are associated with all institutions.

The link processor 4 identifies access links available to each user of the LIS application 12 by means of the list of application object identifiers 20, 21, 22 (FIG. 8) and the institution identifier associated with the selected user role 10. The link processor 4 examines each entry in the access link map 19 (FIG. 7) and checks each active entry, as indicated by the presence of the value ACTV in the Active column 27, for a match between the listed application object identifiers and the Institution identifier of the user role 10 and the application object identifier(s) and the Institution identifier(s) in each entry in the database map 19. If a match is found or if no entry exists in the Application Object column (e.g. that entry applies to all Application Objects) or Institute Column (e.g. it applies to all Institutes), the link processor 4 copies the access link entry information to a list 24.

This list is sorted based on at least one of (a) a determined relative importance of individual access links of said set of access links to a role performable by a user, (b) a determined relative importance of access links in said set of access links, (c) alphabetical order, (d) a determined relative importance of access links of said set of access links to an organization and (e) another determined logical order. In the illustrated embodiment, the list is sorted in the following manner. The first group of link entries are those including sequence numbers 28, sorted in order of those sequence numbers 28. The sequence numbers may be assigned based on any of the sort criteria described above. If two or more access link entries in the list 24 have the same sequence number, those entries are sorted alphabetically by the label 17 defined in the access link map 19. The last group of link entries are those for which a sequence number is not defined. Those link entries are sorted alphabetically by the label 17 defined in the map 19. Once the application server 2 evaluates and sorts the access link entries residing in map 19, path 29 is used by the server 2 to forward to each application object 13, 14 and 15 a submenu label (described in more detail below) obtained from the access link profile 25 in database map 19 of FIG. 7, along with the label 17 and the universal resource locator (URL) 23 for each access link entry in the list 24 (FIG. 1) that has been sorted as described above.

As described above, in a client/server system the application server system 2 is responsible for receiving an information request from a client system 18, performing the data processing needed to satisfy that request, and forwarding the results or information requested back to the client system 18 via a networking connection (not shown) in a known manner. The client system 18 contains a client navigator program, to help the user interact with the server 2.

When the processing of the access link entries, described above, has been completed, the application object 13, 14 and 15, forwards the submenu label, and the label 17 for each access link entry associated with that application object to the client system 18 via the networking connection in the known manner for client/server systems. The client navigator software in the client system 18 alters the help menu display (illustrated, for example, in FIGS. 9, 10 and 11) for the window associated with the application object 13, 14 and 15 to include this information. Initially, the help menu contains a hidden entry. When the client computer 18 receives access link information from the application server 2, the client navigator software makes that hidden entry visible. The label of the previously hidden entry is changed to the submenu label received from the application server 2. When this new menu entry is activated by a user, the client navigation software causes a submenu to be displayed. The submenu is populated in the following manner. For each access link entry 23 (FIG. 7) received from the application server 2, a submenu entry consisting of the label 17 of that access link entry 23 is added to the submenu as a new item. In the application server 2, the URL corresponding to each such entry is added to a global collection in memory 3 (FIG. 1) that is indexed to correspond to the submenu entries. Thus, the access link labels in the newly created submenu are synchronized with the associated access link URLs. When a submenu item is activated by a user, the index of the submenu entry is sent to the application server 2 from the client system 18 via the network connection. The application server 2 then accesses the associated URL, as described below.

Referring to FIG. 9, the graphical user interface displayed by the client navigator software in the client system 18 in response to the data received from one of the permitted application objects (e.g. SUPERVISOR) in the application server 2 is illustrated. In this illustrated example, the user is assumed to have selected access scenario 33 (FIG. 2), which would be an appropriate choice for a phlebotomist at hospital A. A phlebotomist typically employs the specimen entry related portions (application objects) of the application 12. The system administrator has already defined the phlebotomist specific links to external documents for those application objects. For example, the system administrator may define links to the hospital's specimen handling procedures. When the phlebotomist user opens the specimen entry related application objects, the main application 12 performs the security checks discussed earlier in order to determine which access links will be displayed, and data representing those links is transmitted to the client system 18, which displays a modified help menu when the “Help” menu item is activated, all as described above.

The Help menu 56 of the SUPERVISOR display 57 includes a menu item 58. This menu item was initially hidden, but was populated with a label “Hospital A Procedures” when access link information was received from the application server 2. When the menu item 58 is activated, a submenu 54 is displayed and displays a link 60 to the “Critical Escalation Process” and a link 59 to “Phlebotomy Procedures—AH”. The link 60 is seen in map 19 (FIG. 7) to have a sequence number of 1, and the link 59 is seen in map 19 to have a sequence number of 300, meaning that they will always be displayed, in numerical order, in a first group of links. While none are present in the illustrated embodiment, any link with no sequence number will be displayed, in alphabetical order, in a second group of links following all those in the first group. The phlebotomist user can select either one of the access link menu items 59 or 60 from the submenu 54. Because the phlebotomist does not require access to other application objects of the main application 12, such as test result entry, results inquiry, patient reporting, administrative reports, system maintenance, etc., the help menu which may be displayed by the phlebotomist does not have access links defined by the system administrator for those areas.

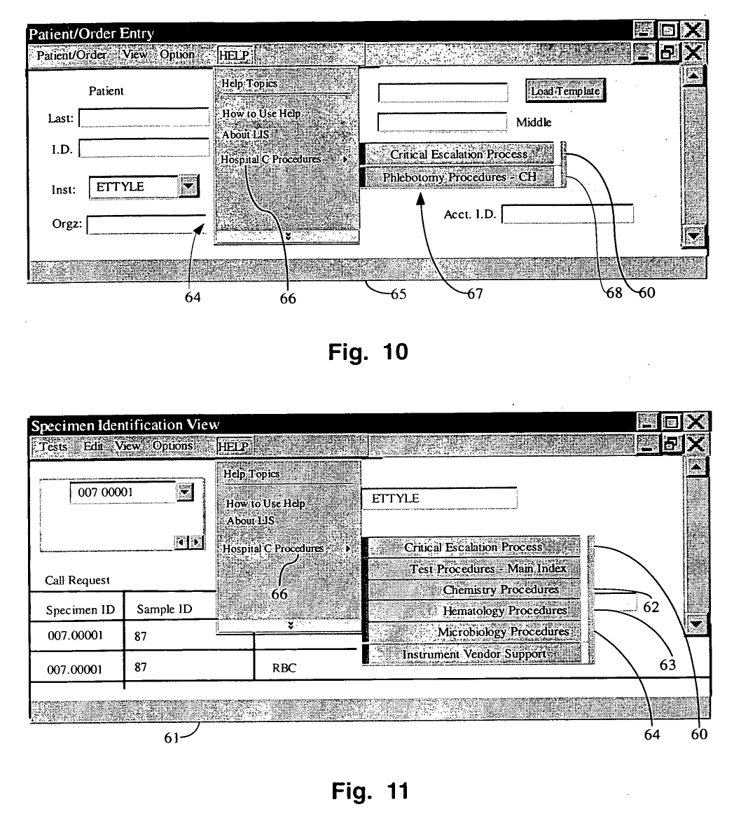

FIG. 10 depicts a similar graphical user interface 65 that has been defined by the system administrator for users associated with a different organization: e.g. Hospital C. Hence, menu item 66 with the label “Hospital C Procedures” is displayed in the Help menu 64. Activation of the menu item 66 causes a submenu 67 to be displayed including a link 60 to the “Critical Escalation Process” and a link 68 to “Phlebotomy Procedures—CH”.

The system 1 can also accommodate the workflow of users in other groups as well. Medical technologists, for example, have needs that differ from those of the phlebotomist. The graphical user interface 61 of FIG. 11 reflects the need of the medical technologist to refer to volumes of standard operating procedures (SOPs) for performing critical tests. These SOPs are controlled documents and multiple paper copies are difficult and expensive to maintain. The SOPs can be easily and inexpensively maintained in electronic form in the document repository 46 (of FIG. 1) and made available to the appropriate users as read-only documents. These document may then be viewed by those users by activating the desired submenu entries 62, 63 and 64, for example.

Upon selection of a particular submenu entry 59, 60 (FIG. 9) 60, 67 (FIG. 10) 60, 62, 63, 64 (FIG. 11) by the user, the client navigator software in the client system 18 sends the index of the selected submenu entry to the application server 2 using the network connection. The application server 2, in turn, uses the index to access the global collection of access link URLs in memory 3 of the application server 2 (FIG. 1) and obtain the access link URL associated with the selected submenu entry. Once the access link URL is obtained, the client navigator opens a command processor, which in FIG. 1 is a web browser 51, and instructs the web browser 51 to navigate to the location within the document repository 46, which may include access to the internet, pointed to by the access link URL. The viewer 51 retrieves and displays the desired document from the document repository 46.

The user may select any number of access links, each of which opens a new web browser display 51 in a separate window. Similarly, the user can simultaneously open any number of permitted application objects 13, 14, 15 from the client navigator, each application object having its own client application object identifier, being displayed in its own window and having its own Help menu. As each application object opens, it sends a request via path 29 to the application server 2 for the access links specific to its application object identifier and the role and organization identifier of the user.

An access link also may include a URL which will provide access to a second external application. The system 1 also maintains an audit trail (not shown) identifying all accesses made to external documents and external applications: The audit trail includes the date and time of external access, an identification of the document or external application accessed, an identification of the user and the source of the access request.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the access link map 19 (of FIG. 1) is illustrated above in the form of a simple table, the access link map may take the form of (a) a plurality of maps, (b) a data repository, (c) a database, (d) a plurality of databases, and (e) a plurality of data repositories. One skilled in the art will understand how to select an appropriate data structure form, and how to structure the access link data in the appropriate manner for the selected data structure form.

What is claimed is:

1. A system enabling a user of an application object, comprising an executable portion of an executable application, to access documents external to said application, comprising:
a map associating a set of access links with
(a) an application object identifier; and
(b) an organization identifier identifying an organization, said set of access links supporting access to documents external to said application;
a link processor for initiating provision of data, the data representing a set of access links, to a user in response to a received organization identifier and a received application object identifier; and
a command processor for initiating access to an external document using a link in said set of access links in response to user command.

2. A system according to claim 1, wherein
said map associates said set of access links with a role identifier, the role identifier identifying a particular user performable role; and
said link processor initiates provision of data representing said set of access links to a user in response to a received role identifier.

3. A system according to claim 1, wherein
said map associates a plurality of sets of access links with
(a) a plurality of application object identifiers, the object identifiers identifying a corresponding plurality of application objects, and
(b) a plurality of organization identifiers, the organization identifiers identifying a corresponding plurality of organizations; and
said link processor selects a set of access links from said plurality of sets of access links in response to a received organization identifier and a received application object identifier, the link processor initiating provision of data representing said selected set of access links to a user.

4. A system according to claim 3, wherein
said map associates said plurality of sets of access links with a plurality of role identifiers identifying a corresponding plurality of roles performed by a user; and
said link processor selects a set of access links from said plurality of sets of access links in response to a received role identifier, the link processor initiating provision of data representing said selected set of access links to a user.

5. A system according to claim 1, wherein
said map comprises at least one of (a) a plurality of maps, (b) a data repository, (c) a database, (d) a plurality of databases, and (e) a plurality of data repositories.

6. A system according to claim 1, wherein
an access link comprises at least one of (i) a universal resource locator, (ii) an internet protocol address, (iii) a storage file directory address, (iv) a storage file address, (v) a communication port address, (vi) a server address and (vii) an address for use in locating a document; and
a document comprises at least one of (a) a web page, (b) an HTML file, (c) a Word document, (d) an SGML document, (e) an XML document, (f) a multimedia file, (g) an Excel file, (h) a Portable Document Format file, (i) an executable file, (1) a text file and (k) an accessible file.

7. A system according to claim 1, wherein
said link processor initiates provision of data representing a menu window for displaying said set of access links to a user.

8. A system according to claim 7, wherein
said link processor determines an order of display of said access links in said menu window based on at least one of (a) a determined relative importance of individual access links of said set of access links to a role performable by a user, (b) a determined relative importance of access links in said set of access links, (c) alphabetical order, (d) a determined relative importance of access links of said set of access links to an organization and (e) another determined logical order.

9. A system according to claim 1, wherein
said command processor initiates access to said external document using a link in said set of access links, the access to the external document being initiated from within said executable application object.

10. A system according to claim 9, wherein said command processor initiates access to said external document using a link in said set of access links concurrently with operation of said executable application object.

11. A system according to claim 1, wherein
said application comprises a laboratory information system and said external document comprises information concerning at least one of (a) test procedures, (b) chemistry procedures, (c) microbiology procedures, (d) hematology procedures (e) phlebotomy procedures, (f) instrument support, (g) an electronic patient medical record, (h) orders to perform patient procedures, (i) laboratory test results and (j) a patient visit.

12. A system according to claim 1, wherein
an access link supports access to a second and different executable application; and
said command processor initiates access to said second application.

13. A system according to claim 1, wherein said organization identifier comprises a location identifier.

14. A system enabling a user of an application object, comprising an executable portion of an executable application, to access documents external to said application, comprising:
a map associating a set of access links with
(a) an application object identifier and
(b) a role identifier identifying a particular user performable role,
said set of access links supporting access to external documents;
a link processor for initiating providing data representing a set of access links to a user in response to a received role identifier and a received application object identifier; and
a command processor for initiating access to an external document using a link in said set of access links in response to user command.

15. A system enabling a user of an application object, comprising an executable portion of an executable application, to access documents external to said application, comprising:
an authorization processor for determining whether a user is authorized to access a particular application object of a plurality of objects within an application in response to a received user identification information and a received application object identifier;
a map associating a plurality of sets of access links with a plurality of application object identifiers identifying a corresponding plurality of application objects, said access links supporting access to external documents; and
a link processor for employing, in response to successful user authorization, said map in selecting a set of access links from said plurality of sets in response to said received application object identifier and for initiating providing data representing said selected set of access links to a user.

16. A system according to claim 15, wherein
said map associates said plurality of sets of access links with at least one of (a) a role identifier identifying a user performable role and (b) an organization identifier identifying an organization.

17. A system according to claim 16, wherein said link processor selects said set of access links from said plurality of sets in response to at least one of (a) a received role identifier identifying a user performable role and (b) a received organization identifier identifying an organization.

18. A system according to claim 15, including a command processor for initiating access to an external document using a link in said set of selected access links, the command processor initiating access from within an executable application object.

19. A system according to claim 15, wherein
said plurality of sets of access links include prioritized sets of access links; and
said link processor selects a single set of access links from said plurality of sets based on set priority.

20. A system according to claim 15, wherein said authorization processor determines whether a user is authorized to access an external document in response to received user identification documentation, the system further comprising
a command processor for inhibiting access to an external document using a link in said set of selected access links in response to a denial of user authorization.

21. A system according to claim 15, wherein
said authorization processor determines whether a user is authorized to access an external document using a link in said selected set of access links in response to received user identification information; and
said link processor inhibits providing data representing an access link to a user in response to a denial of user authorization to access said external document generated by said authorization processor.

22. A system according to claim 15, wherein
said authorization processor maintains an audit trail identifying access to external documents by storing records identifying at least one of (a) a document accessed, (b) a time and date of access, (c) an entity accessing a document and (d) a source of an access request.

23. A method for enabling a user of an application object, comprising an executable portion of an executable application, to access documents external to said application, comprising the steps of:
associating a set of access links with
(a) an application object identifier and
(b) an organization identifier identifying an organization,
said set of access links supporting access to external documents;
initiating providing data representing a set of access links to a user in response to a received organization identifier and a received application object identifier; and
initiating access to an external document using a link in said set of access links in response to a user command.

24. A method for enabling a user of an application object, comprising an executable portion of an executable application, to access documents external to said application, comprising the steps of:
associating a set of access links with
(a) an application object identifier and
(b) a role identifier identifying a particular user performable role,
said set of access links supporting access to external documents;
initiating providing data representing a set of access links to a user in response to a received role identifier and a received application object identifier; and
initiating access to an external document using a link in said set of access links in response to a user command.

25. A method of enabling a user of an application object, comprising an executable portion of an executable application, to access documents external to said application, comprising the steps of:
determining whether the user is authorized to access a particular application object of a plurality of objects within an application in response to received user identification information and a received application object identifier;
associating a plurality of sets of access links with a plurality of application object identifiers identifying a corresponding plurality of application objects, said access links supporting access to external documents; and
in response to user authorization, selecting a set of access links from said plurality of sets of access links in response to said received application object identifier and initiating providing data representing said selected set of access links to the user.
